(19) United States
(12) Patent Application Publication
(10) Pub. No.: US 2013/0292111 A1
(43) Pub. Date: Nov. 7, 2013

(54) METHOD OF CONSTRUCTING A WELL LOG OF A QUANTITATIVE PROPERTY FROM SAMPLE MEASUREMENTS AND LOG DATA

(71) Applicant: IFP Energies nouvelles, (US)

(72) Inventor: Tristan EUZEN, RUEIL-MALMAISON (FR)

(73) Assignee: IFP Energies nouvelles, Rueil-Malmaison Cedex (FR)

(21) Appl. No.: 13/858,974

(22) Filed: Apr. 9, 2013

(30) Foreign Application Priority Data
Apr. 26, 2012 (FR) 12/01229

(51) Int. Cl. G01V 11/00; E21B 41/00

(52) U.S. Cl. CPC G01V 11/002; E21B 41/0092
USPC 166/250.02; 702/11; 702/12; 702/8; 166/250.01

(57) ABSTRACT

A method of constructing a well log of a quantitative property representative of a porous formation, from sample measurements and log data, is disclosed. A quantitative property (mineralogical proportions) of samples selected from among a set of samples is measured and each sample is grouped into homogeneous classes regarding the log data. The average value of the quantitative property is then determined in each class. A well log representing the probability of assigning a sample to each class as a function of depth is constructed. Finally, the well log representing the quantitative property as a function of depth is constructed from the log representing the assignment probability and from the average values.

Reference is made to French Patent Application Serial No. 12/01,229, filed on Apr. 26, 2012, which application is incorporated herein by reference in its entirety.

### BACKGROUND OF THE INVENTION

1. Field of the Invention

The present invention relates to development of underground formations such as hydrocarbon reservoirs. In particular, the invention relates to a method of analyzing well logs in order to evaluate, as a function of depth, quantitative properties representative of the formations.

2. Description of the Prior Art

What is referred to as a well log is a measurement of the characteristics of the rocks penetrated by a borehole, obtained by sondes. In general terms, the term “well log” applies to any record of a characteristic of a geological formation penetrated by a borehole as a function of depth.

Well logs have to be interpreted to provide the information required by reservoir engineers in charge of the exploration or the development of the underground medium. Once interpreted, these log data provide information such as the resistivity, the density, the porosity or the permeability of the materials traversed.

The term “well log” also applies to the logs resulting from the interpretation of one or more logs. After interpretation, some logs yield qualitative information, others quantitative information.

The petroleum industry, and more precisely the exploration and development of reservoirs, notably petroleum reservoirs, requires knowledge which is as reliable as possible of the underground geology to efficiently provide reserves evaluation, production modelling or development management. Indeed, determining the location of a production well or of an injection well, the drilling mud composition, the completion characteristics, selecting a hydrocarbon recovery method (such as waterflooding for example) and the parameters required to implement this method (such as injection pressure, production flow rate, etc.) requires good knowledge of the reservoir. Knowing the reservoir notably requires knowledge of the petrophysical properties of the subsoil at any point in space.

The petroleum industry has therefore combined for a long time field (in-situ) measurements with experimental modelling (performed in the laboratory) and/or numerical modelling (using softwares).

Conventional quantitative log analysis methods are known. Traditionally, quantitative log evaluation aims to evaluate the volumes of fluids in place in a reservoir and their mobility. The three main parameters to be quantified are the porosity, the permeability and the fluid saturations. These data are then used to estimate the volumes of hydrocarbons in place, to determine the most suitable development techniques and to predict the productivity of the wells and the recovery rates for economic calculations. With the recent development of unconventional reservoirs and their exploitation through multiple hydraulic fracturing along horizontal drains, other parameters such as the organic matter content or the geomechanical properties of the reservoir have become dominating in the quantitative evaluation of logs.

However, with these known methods, it is difficult to integrate log data with quantitative measurements on cores or cuttings because these different types of information have variable sampling frequencies and spatial resolutions, which leads to complex and non-linear relations that makes it delicate to use petrophysical models based on a linear relation between the proportions of minerals and the log signature.

### SUMMARY OF THE INVENTION

The invention relates to a method of constructing a well log of a quantitative property representative of a porous formation, well suited to complex reservoirs and allowing core and cuttings data to be integrated.

In general terms, the invention relates to a method of constructing a well log of a quantitative property representative of a porous formation penetrated by at least one borehole, from a set of samples from the porous formation taken at depths for which log data are available. The method comprises the following stages:

a) measuring at least one quantitative property of samples selected from among the set of samples;

b) analyzing the log data to group each one of the samples selected into homogeneous classes

c) determining an average value for the at least one quantitative property in each one of the classes;

d) constructing a well log representing a probability of assigning a sample to each one of the classes as a function of depth in the borehole; and

e) constructing the well log representing the quantitative property as a function of depth in the borehole from the log representing an assignment probability and from the average values.

According to the invention, the log representing the quantitative property can be constructed using the formula as follows:

$${C}_{a}^{Z} = {\sum }_{i} {P}^{Z} ( {f}_{i} ) \cdot {C}_{a} ( {f}_{i} )$$

with:
Cₐ(fᵢ) being an average value of the quantitative property within class fi;
P^{Z}(fᵢ) being a probability of assignment to class fᵢ, as a function of depth Z; and
Cₐ^{Z} being a quantitative property at depth Z.

According to the invention, the quantitative property can be selected from among the following properties: mineralogical proportion of samples, lithology, matrix density and porosity. The log data can be selected from among: gamma ray, neutron porosity, density, sonic logs.

The invention also relates to a method of optimizing a development of an underground formation penetrated by at least one borehole, comprising:

constructing a well log representing a mineralogical proportion as a function of depth, using the method according to the invention;
using the well log obtained in the previous stage for deducing parameters related to a quality of the underground formation, such as density, porosity, brittleness or organic matter content; and
optimizing the development of the underground formation by selecting a most prospective and most suitable intervals for a completion type considered, as a function of the parameters related to a quality of the underground formation.

### BRIEF DESCRIPTION OF THE DRAWING

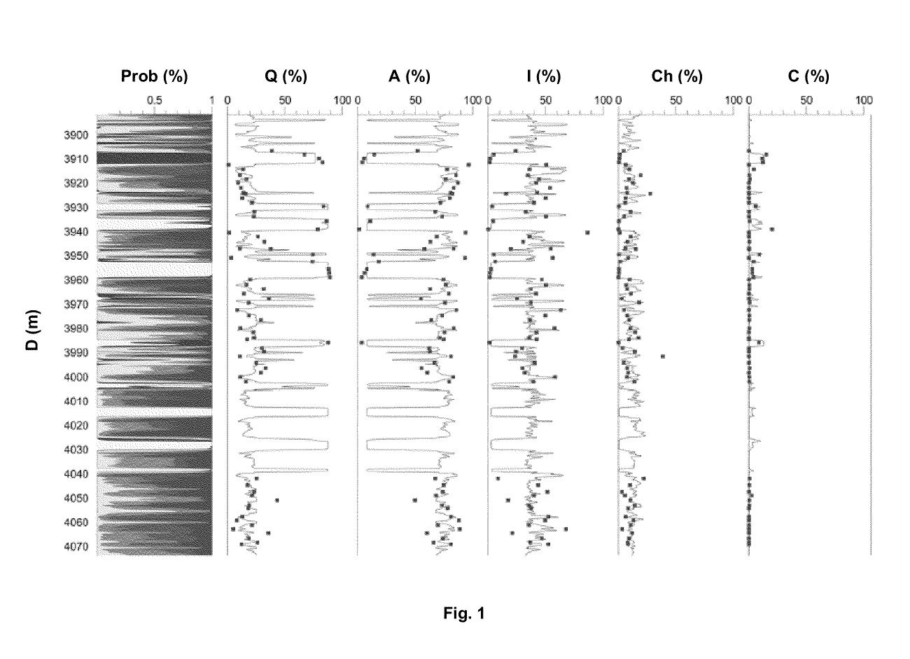

Other features and advantages of the method according to the invention will be clear from reading the description hereafter of embodiments given by way of non-limitative example, with reference to FIG. 1, which shows mineralogical proportions obtained using the method according to the invention (in full line) compared with mineralogical proportions measured on cores (black dots).

### DETAILED DESCRIPTION OF THE INVENTION

The method according to the invention permits construction of a well log of a quantitative property representative of a porous formation penetrated by at least one borehole which provides information on the mineralogical proportion of the materials of the formation as a function of depth in a borehole.

The method uses conventional logs (gamma ray, neutron porosity, density, sonic) and a set of samples from the porous formation taken at depths for which log data are available.

The invention is described in the case of the construction of a mineralogical proportion log. The method comprises the following stages:

a) measuring mineralogical proportions of samples selected from among a set of samples,

b) analyzing the log data to group each selected sample into homogeneous classes;

c) determining an average mineralogical proportion of each class;

d) constructing a first well log representing a probability of assigning a sample to each class as a function of depth in a borehole; and

e) constructing a second well log representing the mineralogical proportions as a function of depth in the borehole from the first log and from the average mineralogical proportions of each class.

a) Measuring the Mineralogical Proportions of Training Samples

The samples can be cores or cuttings. The training samples are selected from among the available samples. Measuring mineralogical proportions on this type of sample is well known. They can be obtained for example from scanning electron microscopy and X-ray energy-dispersive spectroscopy techniques.

For example, proportions of quartz, dolomite, illite-smectite, chlorite are determined.

b) Grouping the Samples into Classes (Electrofacies)

The mineralogical proportions measured on the training samples are used to define classes, denoted by fᵢ, representative of the total variation range observed in the data. A supervised approach is then used to define training samples characteristic of each class.

Such a method is for example described in EP Patents 0,671,017, 0,903,592 and 1,189,167.

The principle of this method is as follows:

identifying log portions characteristic of each class which was previously defined on a basis of the mineralogical compositions;
using the log portions as training samples to define distribution laws for the logs of each class; and
using the distribution laws to calculate the class assignment probability logs (discriminant analysis).

The Easytrace® software (IFP Energies nouvelles, France) can for example be used to carry out this stage.

The classes are thus defined and calibrated from quantitative mineralogical data. In conventional methods, the classes are generally calibrated on geological facies defined from a qualitative interpretation (grain size, sedimentary structures, bioturbation, etc.). The mineralogical composition is directly related to the physical properties of the rock and it is a source of objective information for calibration of the classes (as opposed to a geological interpretation).

c) Determining an Average Mineralogical Proportion for Each Class

For each class, it is possible to calculate, using the mineralogical proportion measurements relative to the training samples, an average mineralogical proportion of each class fᵢ. This average proportion of class fᵢ is denoted by Cₐ(fᵢ).

d) Constructing a Class Assignment Probability Log

For each one of these classes (electrofacies), a probability log is calculated. It defines the probability of belonging to each class fᵢ as a function of the depth in the borehole. The probability of assignment to class fᵢ as a function of depth Z is denoted by P^{Z} (fᵢ).

The following method can be used:

the probability of belonging to a class for a sample is calculated using Bayes' formula that accounts for well log characteristics of the sample and intra-class probability laws determined on the training sample;
for example, in the Easytrace® software, Gaussian (linear or quadratic) or non-parametric probability laws can be used.

The Easytrace® software (IFP Energies nouvelles, France) can for example be used to carry out this stage.

e) Constructing Mineralogical Proportion Logs as a Function of Depth

Finally, these probability logs P^{Z}(fᵢ) are combined with the average mineralogical compositions Cₐ(fᵢ) of each class in order to calculate mineralogical proportion logs as a function of depth, using the formula as follows:

$${C}_{a}^{Z} = {\sum }_{i} {P}^{Z} ( {f}_{i} ) \cdot {C}_{a} ( {f}_{i} )$$

with:
Cₐ(fᵢ) being an average mineralogical proportion of class fi;
P^{Z}(fᵢ) being a probability of assignment to class fᵢ, as a function of depth Z; and
Cₐ^{Z} being a mineralogical proportion at depth Z.

When the samples are cuttings, the classes are defined by grouping the grains by lithotype, according to their mineralogy and texture. The training samples are then selected by identifying the well log signature of various lithotypes in the sampling interval.

The method according to the invention uses the class assignment probabilities to calculate a continuous variable (mineralogical logs in the example presented here) rather than the class itself (discrete variable). In the conventional approach, the probabilities are used to measure the class assignment reliability. According to the invention, high probabilities are not necessarily sought and tend to produce a low variability. The goal is to the contrary to capture the gradual lithologic changes reflected in progressive and subtle variations in the logs.

The invention has been described for the construction of a mineralogical proportion log. It is however possible to construct any well log reflecting the evolution of a quantitative property representative of the porous formation, as a function of depth, such as: lithology, matrix density and porosity.

### EXAMPLES

The method has been tested on the data of a vertical well of the oil field. The data used comprise four conventional well logs (gamma ray, neutron porosity, density and sonic) and the mineralogical compositions measured on 67 core samples.

Six classes were defined accounting for the variable proportions of quartz, dolomite, illite-smectite and chlorite.

Twenty of the 67 samples were used as training samples on the well logs (supervised approach).

Mineralogical logs were calculated using the method described above and compared with the mineralogical compositions measured on the cores. The calibration to core data was adjusted iteratively by modifying the average mineralogical composition of the classes and the selection of the training samples. The calculated mineralogical log is compared with the measured values. If the calibration is considered insufficient, the classification is adjusted in two ways:

modifying the selection of the log portions used as training samples, which modifies the intra-class distribution laws and the probability logs obtained during the classification,
modifying the average composition of certain classes. A certain degree of freedom is available for varying the theoretical average composition of a class in order to adjust the mineralogical log.

Perfect calibration to the core data is not required. It is recalled that well logs average the information with a spatial resolution that is lower than that of a spot measurement on a core sample.

FIG. 1 shows mineralogical proportions obtained with the method according to the invention (full line) compared with mineralogical proportions measured on cores (black dots). In the left-hand part of FIG. 3, the probability log (Prob) is shown as a function of depth D. The proportions of quartz (Q), clay (A), illite (I), chlorite (Ch) and carbonates (C) are then shown from left to right.

### ADVANTAGES

This method is of particular interest for integrating conventional well logs with quantitative data measured on cuttings, for the following reasons:

cuttings and conventional logs are available data that are readily accessible in most boreholes (as opposed to more specialized cores or logs, rarer and generally costlier). Conventional logs are understood to be logs that are generally routine data in almost all boreholes, such as GR, SP, Density, Neutron and Resistivity, or that are relatively frequent such as Sonic or PEF. On the other hand, unconventional logs are rarer and costlier: Spectral GR, geochemical logs, NMR, etc.,
cuttings have a low sampling frequency (generally 3 to 5 m) and each sample corresponds to a grain mixture that averages the information on the interval sampled. It is therefore necessary to integrate the data obtained from the cuttings in the well logs so as to extract therefrom information at a higher frequency and to propagate it along the well.

### APPLICATION

It is important to quantify for example the mineralogy in unconventional reservoirs. Indeed, from mineralogical proportion logs as a function of depth, notably assessment of the geomechanical properties and the organic matter content of reservoirs from well logs is possible.

The result is a capacity to define an optimum production scheme for the formation being studied.

Thus, the invention also relates to a method of optimizing development of an underground formation penetrated by at least one borehole, comprising:

constructing a well log representing a mineralogical proportion as a function of depth, using the method according to the invention;
using the well log to deduce parameters related to the quality of the underground formation (conventional or unconventional reservoir), such as matrix density, porosity, brittleness or organic matter content;
optimizing the development of the underground formation by selecting most prospective and most suitable intervals for the completion type being considered.

For example, a mineralogical well log can be constructed using the method according to the invention. Then, using this mineralogical log, it is possible to calculate a brittleness log in order to determine which intervals will have the best response to hydraulic fracturing and which intervals will, on the contrary, be barriers stopping the propagation of fractures. Finally, the development of the underground formation can be optimized by placing a horizontal drain in an optimum way so as to fracture the most brittle intervals and/or to confine fracturation in the desired zone by means of the fracturation barriers identified in the well logs.

1-5. (canceled)

6. A method of constructing a well log of a quantitative property representative of a porous formation penetrated by at least one borehole, from a set of samples from the porous formation taken at depths for which log data are available, comprising:
a) measuring at least one quantitative property of samples selected from among the set of samples;
b) grouping each one of the samples selected into homogeneous classes by an analysis of the log data;
c) determining an average value for the quantitative property in each one of the classes;
d) constructing a well log representing a probability of assigning a sample to each one of the classes as a function of depth in the at least one borehole; and
e) constructing the well log representing the quantitative property as a function of depth in the at least one borehole from the log representing an assignment probability and from the average values.

7. A method as claimed in claim 6, wherein the log representing the quantitative property is constructed using the formula as follows:
$${C}_{a}^{Z} = {\sum }_{i} {P}^{Z} ( {f}_{i} ) \cdot {C}_{a} ( {f}_{i} )$$
with:
Cₐ(fᵢ) being an average value of the quantitative property within class fi;
P^{Z}(fᵢ) being a probability of assignment to class fᵢ, as a function of depth Z;
Cₐ^{Z} being quantitative property at depth Z.

8. A method as claimed in claim 6, wherein the quantitative property is selected from: mineralogical proportion of samples, lithology, matrix density and porosity.

9. A method as claimed in claim 7, wherein the quantitative property is selected from: mineralogical proportion of samples, lithology, matrix density and porosity.

10. A method as claimed in claim 6, wherein the log data are selected from: gamma ray, neutron porosity, density and sonic logs.

11. A method as claimed in claim 7, wherein the log data are selected from: gamma ray, neutron porosity, density and sonic logs.

12. A method as claimed in claim 8, wherein the log data are selected from: gamma ray, neutron porosity, density and sonic logs.

13. A method as claimed in claim 9, wherein the log data are selected from: gamma ray, neutron porosity, density and sonic logs.

14. A method as claimed in claim 6 of optimizing development of an underground formation penetrated by at least one borehole, comprising:
a) constructing a well log representing a mineralogical proportion as a function of depth;
b) using the well log obtained in a) for obtaining parameters related to a quality of the underground formation selected from density, porosity, brittleness or organic matter content; and
c) optimizing development of the underground formation by selecting a most prospective and most suitable intervals for a completion type under consideration as a function of the parameters related to the quality of the underground formation.
